(19) United States
(12) Patent Application Publication
(10) Pub. No.: US 2025/0334414 A1
(43) Pub. Date: Oct. 30, 2025

(54) METHOD, COMPUTER-READABLE MEDIUM, AND DEVICE FOR A TRANSPORTATION SERVICE PLATFORM

(71) Applicants: Hossein Kosari, Newmarket (CA); Mohsen Mosafer, North York (CA)

(72) Inventors: Hossein Kosari, Newmarket (CA); Mohsen Mosafer, North York (CA)

(21) Appl. No.: 18/647,518

(22) Filed: Apr. 26, 2024

(51) Int. Cl. G01C 21/34; G01C 21/36

(52) U.S. Cl. CPC G01C 21/3438; G01C 21/3461; G01C 21/3679

(57) ABSTRACT

A computer-implemented method for providing a transportation service platform. The method comprises receiving a request from a user for a ride from a start location to an end location, the start location being located within a predetermined zone associated with one or more predetermined destinations accessible from the predetermined zone, the end location being restricted to one of the predetermined destinations, the predetermined zone comprising at least one other user having requested a ride to at least one other end location from at least one other start location within the predetermined zone. The method further comprises calculating a route from a location of a vehicle to the end location, the route comprising the start location and the at least one other start location. The method further comprises dispatching, via a vehicle computing device associated with the vehicle, the vehicle to follow the route.

### TECHNICAL FIELD

The present disclosure relates to a transportation service platform and, more particularly, to a method, computer-readable medium, and device for providing rides to users from one location to another location, such as a commercial destination.

### BACKGROUND

Shopping in physical locations has decreased due to the rise in online shopping. Physical stores have a desire to increase shopping in their physical locations. One of the reasons customers shop online is the difficulty of accessing physical stores. Traditional methods include private vehicles, ride sharing services, taxis, and public transportation. Private vehicles, ride sharing services, and taxis are often too expensive. Public transportation is often inconvenient.

The present disclosure aims at providing an improved method, computer-readable medium, and device for a transportation service platform.

### SUMMARY

There is provided a computer-implemented method for providing a transportation service platform. The method comprises receiving a request from a user for a ride from a start location to an end location, the start location being located within a predetermined zone associated with one or more predetermined destinations accessible from the predetermined zone, the end location being restricted to one of the predetermined destinations, the predetermined zone comprising at least one other user having requested a ride to at least one other end location from at least one other start location within the predetermined zone. The method comprises calculating a route from a location of a vehicle to the end location, the route comprising the start location and the at least one other start location. The method comprises dispatching, via a vehicle computing device associated with the vehicle, the vehicle to follow the route.

Optionally, the one or more predetermined destinations may be located in proximity to one another.

Optionally, the one or more predetermined destinations may be located within the predetermined zone.

Optionally, the one or more predetermined destinations may be located in proximity to the predetermined zone.

Optionally, the predetermined zone may be associated with only one predetermined destination.

Optionally, the end location may be the same as the at least one other end location.

Optionally, the predetermined zone may be one of a plurality of predetermined zones in a city.

Optionally, the locations and areas of the plurality of predetermined zones may be determined based on locations of commercial destinations, population distribution and size, shopping patterns, or traffic patterns.

Optionally, two or more of the plurality of predetermined zones may overlap.

Optionally, the method may further comprise calculating a pickup time for the user based on traffic patterns, availability of the vehicle, availability of the at least one other user, or a level of busyness at the end location.

Optionally, at least one of the predetermined destinations may be a commercial destination or a transportation hub.

Optionally, at least one of the predetermined destinations may be a mall, a shopping centre, a pharmacy, a grocery store, a big box store, a department store, a restaurant, a bar, a cinema, a university, a school, an event, a festival, a main street, or a downtown shopping district.

Optionally, the vehicle may be restricted to providing rides to users located within the predetermined zone.

Optionally, the method may further comprise sending the route to the vehicle computing device for display on a graphical user interface thereof.

Optionally, the method may further comprise displaying the one or more predetermined destinations accessible from the predetermined zone on a graphical user interface of a user computing device associated with the user. Optionally, the method may further comprise receiving an input via the graphical user interface selecting one of the one or more predetermined destinations as the end location.

Optionally, the method may further comprise receiving a further request from the user for a further ride from a second start location to a second end location, wherein the second start location is the same as the end location, and wherein the second end location is another one of the one or more predetermined destinations, a location within the predetermined zone, or the start location.

Optionally, the method may further comprise receiving a further request from the user for a further ride from a second start location to a second end location, wherein the second start location is a predetermined location associated with a second predetermined zone, and wherein the second end location is within the second predetermined zone.

Optionally, the method may further comprise determining the boundaries of the predetermined zones.

According to a further aspect of the disclosure, there is provided non-transitory computer-readable medium comprising computer instructions stored thereon, wherein the computer instructions, when executed by one or more processors, causes the one or more processors to perform the method described above in connection with the first aspect of the disclosure.

According to a further aspect of the disclosure, there is provided a computing device comprising one or more processors operable to perform the method described above in connection with the first aspect of the disclosure.

### BRIEF DESCRIPTION OF THE DRAWINGS

Further features and exemplary advantages will become apparent from the following detailed description, taken in conjunction with the appended drawings, in which:

FIG. 1 is a logical modular representation of an exemplary system comprising a server for providing a transportation service platform, in accordance with an embodiment;

FIG. 2 is a flow chart of an exemplary method for providing a transportation service platform, in accordance with an embodiment;

FIG. 3 shows various graphical user interfaces, in accordance with an embodiment;

FIG. 4 shows various graphical user interfaces, in accordance with an embodiment;

FIG. 5 is a flow chart of an exemplary method for providing a transportation service platform, in accordance with an embodiment;

FIG. 6 illustrates an example route calculated by the transportation service platform, in accordance with an embodiment;

FIG. 7 illustrates various example routes calculated by the transportation service platform, in accordance with an embodiment; and

FIG. 8 illustrates an example city comprising a plurality of predetermined zones, in accordance with an embodiment.

### DETAILED DESCRIPTION

There is shown and described a transportation service platform comprising a server, a network, and one or more client computing devices. In a preferred embodiment, the client computing devices are mobile devices, and the users of the platform access the platform through a mobile app on their mobile devices. A user, located in a city, may request a ride from a start location to an end location using the client computing device. The start location may be the current location of the user where the user wishes to be picked up by a vehicle, such as the user's home. The client computing device may send the ride request comprising the start location to the server via the network. The server may have stored in its storage module a map of the city divided up into a plurality of geographical zones. The server may locate the start location of the user within one of these geographical zones. Each zone may be associated with one or more predetermined destinations. The predetermined destinations may be commercial destinations where the user may wish to go shopping, such as a mall, a shopping centre, a pharmacy, a grocery store, a big box store, a department store, or a downtown shopping district. The predetermined destinations may also be other types of destinations, such as a restaurant, a bar, a cinema, a university, a school, an event, a festival, or a main street. The server may send the one or more predetermined destinations associated with the user's zone to the client computing device via the network for display on the client computing device. The user may select one of the predetermined destinations as the end location using the user interface of the client computing device. The client computing device may send the selected destination to the server via the network. Each of the predetermined destinations may be close to one another, for example, because they are all stores within a single shopping mall. The server may group together a plurality of ride requests from a plurality of users within a single zone. The server may calculate a route for a vehicle to pick up one or more users within the zone and to drop off each of the users at the requested end locations. The vehicle may be a minivan, van, or bus in order to accommodate a plurality of users.

By grouping the users into zones, the start locations of the users may be close to one another. Since the zones are associated with predetermined destinations, the end locations may be close to one another. This enables the transportation service platform to calculate a route for the vehicle more efficiently than traditional ride sharing services and thus reduce the use of computational resources, since it reduces the computational complexity of the problem, as compared to traditional ride sharing services where users' start locations and end locations can be anywhere in the city. This also enables the transportation service platform to calculate routes that are more efficient for the vehicle in terms of minimizing the time to complete the route, the distance of the route, the amount of fuel used to complete the route, and the cost of completing the route. The transportation service platform may provide transportation services that are more convenient than public transportation and less expensive than private vehicles, traditional ride sharing, or taxis.

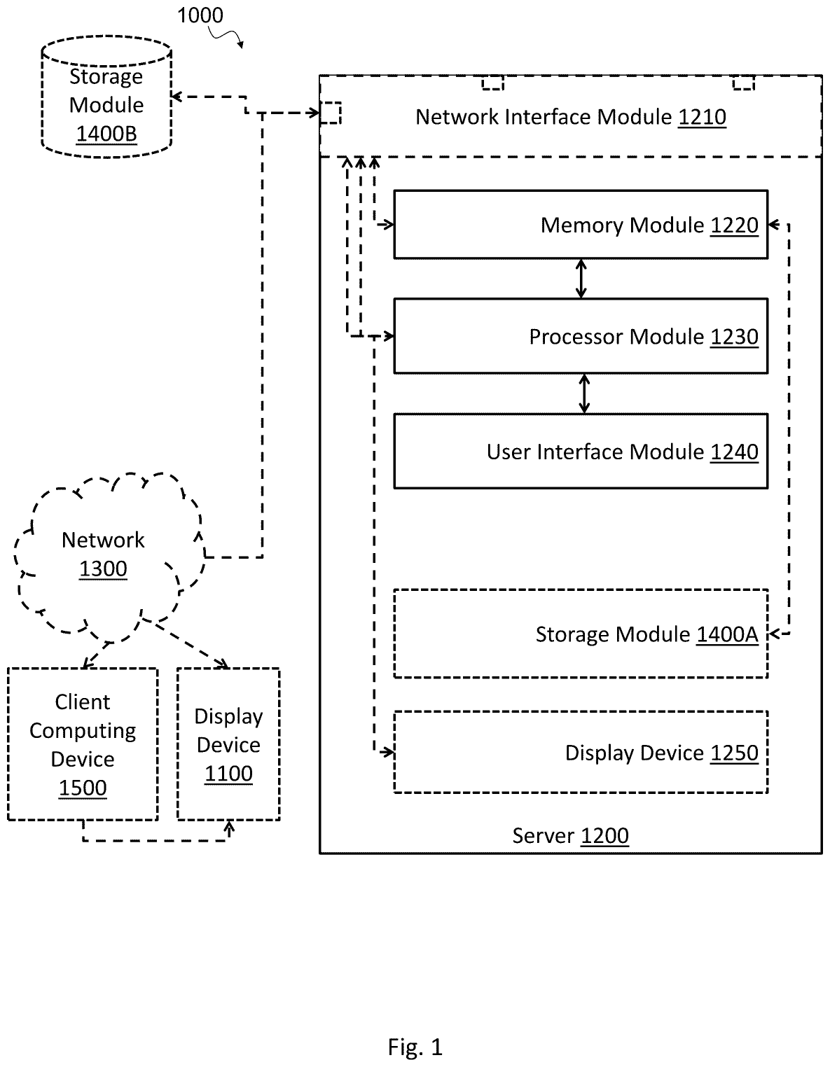

FIG. 1 shows a logical modular representation of an exemplary system 1000 in accordance with the teachings herein. The system 1000 comprises a server 1200 for providing a transportation service platform. The server 1200 comprises a memory module 1220, a processor module 1230, a user interface module 1240, a network interface module 1210, and a storage module 1400A. The storage module 1400A may be a standard hard disk drive, a solid state drive, a tape drive, RAID storage, or any form of non-volatile memory that meets the various requirements for storing and retrieving data. A storage module 1400B may be externally connected to the server 1200. The storage module 1400B may be a remote network storage connected to the server 1200 via the network 1300 (not shown). Alternatively, or in addition, the storage module 1400A may be integrated with the server 1200. The server 1200 may further comprise a display device 1250, which may be a remote display device connected to the server 1200 through the network 1300 (not shown), a display device directly connected to the server 1200 (not shown), or an integrated display device 1250. The network interface module 1210 is for sending and receiving data through the network 1300 to and from the plurality of remote client computing devices 1500.

The system 1000 also comprises a plurality of client computing devices 1500, which may be personal computers, laptops, tablets, or mobile devices. In the preferred embodiment, the client computing devices 1500 are mobile devices. Each of the client computing devices 1500 may further comprise a display device 1100, which may be a remote display device 1100 connected to the client computing device 1500 through the network 1300, a display device 1100 directly connected to the client computing device 1500, or an integrated display device (not shown). The client computing devices 1500 may further comprise a network interface module (not shown) for sending and receiving data through the network 1300 to and from the server 1200.

The system 1000 further comprises a network 1300 for connecting the server 1200 and the client computing devices 1500. Communication over the network 1300 may occur using e.g., TCP/IP and Ethernet or ATM SONET/SDNET; over air, copper wires, optical fiber, or any other physical support capable of carrying data. In the preferred embodiment, the network 1300 is the Internet. The client computing devices 1500 may be connected to the network 1300 in a variety of ways, such as via a wired network, via a cellular network, via Wi-Fi, or via Bluetooth. A skilled person will understand that the server 1200 may comprise multiple servers 1200 in a cluster or other similar shared-processing or distributed-processing architectures, whether in a single location or over cloud computing.

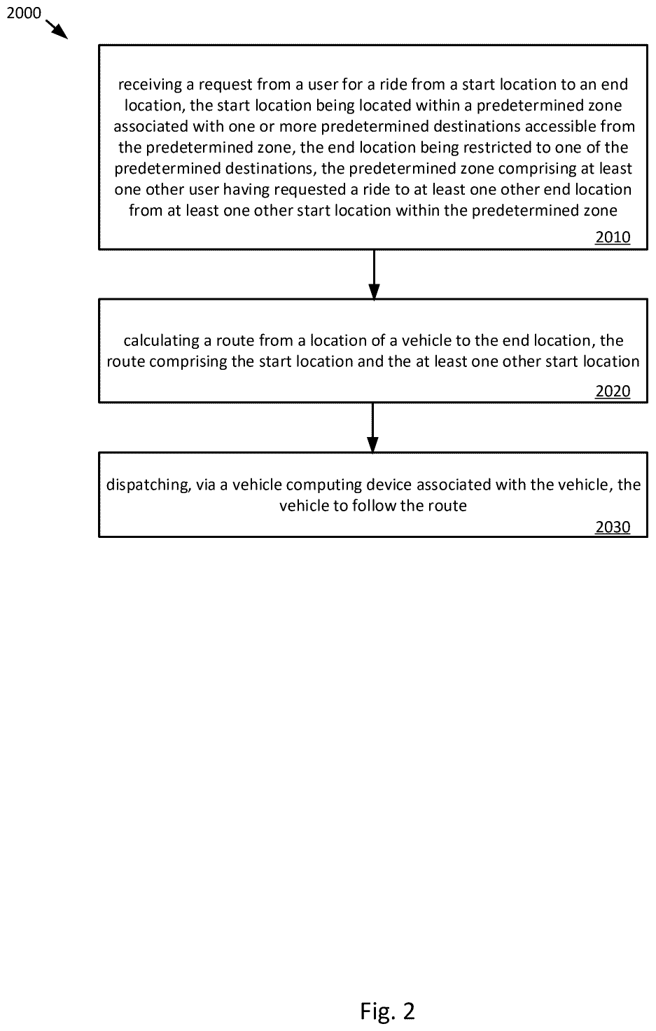

Reference is now made concurrently to FIG. 1 and FIG. 2, which shows an exemplary method 2000 for providing transportation service platform. The method 2000 comprises the step 2010 of receiving a request from a user for a ride from a start location to an end location, the start location being located within a predetermined zone associated with one or more predetermined destinations accessible from the predetermined zone, the end location being restricted to one of the predetermined destinations, the predetermined zone comprising at least one other user having requested a ride to at least one other end location from at least one other start location within the predetermined zone. The user may enter the start location on the client computing device 1500, for example by entering an address. The client computing device 1500 may alternatively automatically determine the start location, for example by using a Global Positioning System (GPS) component of the client computing device 1500. Alternatively, the client computing device 1500 may retrieve the start location from a storage module. The start location may be the location where the user wishes to be picked up by a vehicle of the transportation service. For example, the start location may be the home of the user. The client computing device 1500 may send the start location to the server 1200 via the network 1300.

The start location is located in a predetermined zone. The city in which the user is located may be divided up into one or more predetermined geographic zones. The zones may be mutually exclusive or they may partially overlap. The zones may exhaust the geographic space in the city, or there may be gaps in the city not covered by any zone. The transportation service may not be available in said gaps. The zones may be automatically calculated or determined by a computer, such as the server 1200. Alternatively, the zones may be manually determined by a person. The zones may be stored in the storage module 1400 of the server 1200. Alternatively, the zones may be stored on a storage module of the client computing device 1500. The zones may be stored in a map representation. The zones may alternatively be stored in a numerical data format, for example specifying the geographical coordinates of the boundaries of the zones. A skilled person will understand that the zones may be stored in any other applicable data format. The client computing device 1500 or the server 1200 may determine the zone in which the start location is located. The server 1200 may send said zone to the client computing device 1500 via the network 1300.

Each zone is associated with one or more predetermined destinations that are accessible from the zone using the transportation service platform. The predetermined destinations may be commercial destinations where the user may wish to go shopping, such as a mall, a shopping centre, a pharmacy, a grocery store, a big box store, a department store, or a downtown shopping district. The predetermined destinations may also be other types of destinations, such as a restaurant, a bar, a cinema, a university, a school, an event, a festival, or a main street. The end location that the user selects for the ride must be one of the predetermined destinations associated with the user's zone. Unlike traditional ride sharing platforms, the user cannot use the transportation service to get a ride to any location whatsoever in the city. The transportation service only provides rides to a limited number of predetermined destinations associated with the user's zone. The predetermined destinations associated with a zone may be automatically determined by a computer, such as the server 1200, or manually by a person. The predetermined destinations may be periodically updated, such as daily, weekly, monthly, or annually. The predetermined destinations may be stored in the storage module 1400 of the server 1200 or in a storage module of the client computing device 1500. The server 1200 may send the predetermined destinations for the user's zone to the client computing device 1500 via the network 1300. The client computing device 1500 may display the predetermined destinations on the display device 1100 to enable the user to select one of the predetermined destinations as the end location. Alternatively, the user may enter the end location manually, for example as an address, and the client computing device 1500 may accept the end location if it is one of the predetermined destinations or reject it otherwise.

The server 1200 may receive ride requests from one or more other users at different start locations located within the same zone as the first user. The server 1200 may coordinate a vehicle to simultaneously provide a ride to the first user and said other users. That is the users may share the vehicle for the ride. The vehicle may be large enough to accommodate a large number of users, such as a minivan, van, or bus. The transportation service platform may provide rides to users in more than one zone and in more than one city. The transportation service platform only coordinates shared rides between users located in the same zone.

The method 2000 further comprises the step 2020 of calculating a route from a location of a vehicle to the end location, the route comprising the start location and the at least one other start location. The route may be calculated based on the current time, the rider capacity of the vehicles that are in use, the start and end points of the riders' trips, the number of riders, and any traffic restrictions that are in place. The route may be calculated by the server 1200 or by a vehicle computing device associated with the vehicle providing the ride. The vehicle computing device may be one of the client computing devices 1500. The vehicle computing device may be a mobile device of the driver of the vehicle. Alternatively, the vehicle computing device may be a computer integrated in the vehicle. The calculated route may be an optimal route. The optimal route may minimize the fuel consumed, the total time the route takes to complete, the distance of the route, the waiting time of the users, vehicle utilization, or any other relevant variable. The route may begin with the current location of the vehicle and may end with the end location of one of the users. The route comprises the start locations of the users. Generally, the vehicle may pick up each of the users at each of the start locations and then drop off each of the users at each of the end locations. It is also possible that some end locations come before some start locations. A constraint on calculating the route may be that for any given user, that user's start location may come before that user's end location. The end locations of two or more of the users may be the same location. Alternatively, the end locations of each of the users may be different. Since the start locations of the users are located in the same zone, the start locations may be close to one another. Since the end locations are restricted to a set of predetermined destinations that may be chosen to be close to one another, the end locations of the users may be close to one another. This enables the server 1200 to efficiently and cost effectively provide a shared transportation service to more than one user at a time.

The method 2000 further comprises the step 2030 of dispatching, via a vehicle computing device associated with the vehicle, the vehicle to follow the route. The server 1200 may send a message to the vehicle computing device via the network 1300. The message may comprise the calculated route and a specified time for commencing the route. The vehicle computing device may display a message on a display device of the vehicle computing device instructing the driver to depart on the route immediately or at a specified time. The vehicle computing device may also provide the message orally. The message dispatching the vehicle may alternatively be delivered as a text message or as a telephone call or over radio. The vehicle may begin following the calculated route at the specified time. The vehicle computing device may comprise a GPS component that enables the vehicle computing device to track the location of the vehicle. The vehicle computing device may periodically send the current location of the vehicle to the server 1200 via the network 1300. The vehicle computing device may display the current location of the vehicle on a map showing the route. The vehicle computing device may provide driving directions to the driver of the vehicle as the vehicle progresses along the route.

Optionally, a user may request a ride for a group comprising more than one rider. The user may enter the number of riders in the group when requesting the ride through the client computing device 1500. The server 1200 may determine the route based on optimizing the number of riders in the vehicle. For example, the server 1200 may attempt to minimize the number of empty seats. The server 1200 may attempt to ensure that there are enough seats for all the riders. The terms “users” and “riders” may be used interchangeably. Generally, the term “user” refers to a person using the transportation platform through the client computing device 1500, while the term “rider” refers to a person riding in a vehicle provided by the transportation service. In general, all users are riders, but not all riders are users. It is also possible for some users not to be riders if they request a ride on behalf of someone else.

Optionally, the one or more predetermined destinations may be located in proximity to one another. For example, the predetermined destinations may be various stores at a shopping mall. The predetermined destinations may be various stores in a downtown shopping district. The predetermined destinations may be various stores located on a main street of a neighborhood. Having the predetermined destinations close to one another may improve the efficiency of the transportation service platform, since all users in a zone may be going to destinations that are close to one another.

Similarly, if the zones are a small size, all the start locations may be close to one another. Having the start locations close to one another and the predetermined destinations close to one another may improve the efficiency of the transportation service platform. It reduces the computational complexity required to calculate the routes, which improves the efficiency of the computer that calculates the routes and reduces the energy consumed by the computer. In some embodiments, a specific vehicle may be assigned to a specific zone. The vehicle may continuously drive a loop from the start locations in the zone to the predetermined destinations. For example, the zone may be a suburban neighborhood and the predetermined destinations may be a grocery store and a pharmacy that are close to one another. The vehicle may act as an on-demand shuttle service driving users back and forth between the suburban neighborhood and the grocery store and pharmacy store. This looping back and forth between starting locations close to one another and predetermined destinations close to one another may provide the optimal efficiency of the transportation service platform.

Optionally, the one or more predetermined destinations may be located within the predetermined zone. For example, the zone may be a neighborhood comprising a main street and the predetermined destinations may be on the main street. As an alternative option, the one or more predetermined destinations may be located in proximity to the predetermined zone. The predetermined destinations may be located outside of the zone and yet be close to the zone. For example, the predetermined destination may be a shopping mall that is outside the neighborhood zone. Optionally, the predetermined destinations may be far away from the zone. For example, the predetermined destination may be an airport, train station, or bus terminal that is located far away from the zone. As another example, the predetermined destination may be a downtown shopping district that is located far away from the suburban neighborhood zone.

Optionally, the predetermined zone may be associated with only one predetermined destination. For example, the predetermined destination may be just a grocery store or just a shopping mall. In this case, the transportation service platform may act as an on-demand shuttle service between the zone and the one predetermined destination.

Optionally, the end location may be the same as the at least one other end location. More than one user in the vehicle may be going to the same destination, such as the grocery store, pharmacy, or shopping mall. For example, the vehicle may pick up each of the users at their homes and drives them to the grocery store.

Optionally, the predetermined zone may be one of a plurality of predetermined zones in a city. The city may be divided up into a plurality of zones. The zones may be exhaustive such that every location in the city is covered by at least one zone. Alternatively, there may be gaps in the zones. The transportation service platform may not be available to provide rides to users located in the gaps. The zones may be mutually exclusive. Two or more of the plurality of predetermined zones may overlap. Two or more of the zones may have some of the same predetermined destinations. There may be different sets of predetermined zones for different predetermined destinations or different categories of destinations. The predetermined zone in which the user is located may be determined based on the user's selection of a predetermined destination or category of predetermined destination. The predetermined zones may change over time.

Optionally, the locations and areas of the plurality of predetermined zones may be determined based on locations of commercial destinations, population distribution and size, shopping patterns, or traffic patterns. The zones may be determined so that they are close to the predetermined destinations so as to minimize the driving time between the start locations and the end locations. The zones may be determined so that they are small so that the distance between different start locations is minimized. The zones may be determined so that they contain a sufficient population size so that there is sufficient demand for the transportation service platform. The zones may be determined based on shopping patterns showing that people located in a particular zone prefer shopping at particular commercial destination. The zones may be determined to avoid busy routes. The zones may be determined to optimize any number of other variables related to the transportation service platform.

Optionally, the method 2000 may further comprise calculating a pickup time for the user based on traffic patterns, availability of the vehicle, availability of the at least one other user, or a level of busyness at the end location. The user may enter a desired pickup time into the client computing device 1500. The client computing device 1500 may send this desired pickup time to the server 1200 via the network 1300. The server 1200 may calculate the pickup time for the user based on this desired pickup time as well as other criteria. For example, the pickup time may be calculated based on the availability of a vehicle to arrive at the start location. The pickup time may be calculated based on the availability of other users. The server 1200 may attempt to coordinate pickup times between different users to optimally fill the vehicle. The pickup time may take into account traffic levels on the route, which will affect how long it takes for the vehicle to arrive at the start location. The pickup time may take into account a level busyness at the end location. For example, the server 1200 may delay the pickup time to a less busy time to reduce the overall level of busyness at the end location. The pickup time may be determined based on other factors in order to optimize other variables.

Optionally, the predetermined destination may be a commercial destination or a transportation hub. Optionally, the predetermined destination may be a mall, a shopping centre, a pharmacy, a grocery store, a big box store, a department store, a restaurant, a bar, a cinema, a university, a school, an event, a festival, a main street, or a downtown shopping district. Optionally, the predetermined destination may be an airport, a train station, or a bus terminal. The transportation platform may be used to access a wide range of destinations, such as restaurants, malls and plazas, bars, cinemas, theaters, events, hotels, entertainment and tourism centers, companies, universities, schools, and religious centers, and other urban events. A skilled person will understand that the transportation platform is not limited to these destinations. The description focuses on the exemplary embodiment of the transportation platform for providing transportation services for the purpose of shopping, but the skilled person will understand that the transportation platform is not limited to this purpose.

Optionally, the vehicle may be restricted to providing rides to users located within the predetermined zone. Vehicles may be assigned to particular zones. Each zone may have one or more vehicles. The vehicles may thus continuously loop between the start locations in the zone and the predetermined destinations. For example, a vehicle assigned to a neighborhood zone may continuously loop between the neighborhood and a shopping mall, picking users up at their homes, dropping them off at the shopping mall, and then returning them home when they are done shopping.

Optionally, the method 2000 may further comprise sending the route to the vehicle computing device for display on a graphical user interface thereof. The route may be displayed on a map on the vehicle computing device. The location of the vehicle on the route may be displayed on the map. The vehicle computing device may provide directions to the drive of the vehicle for following the route. The directions may be displayed visually on the display device of the vehicle computing device or spoken orally by the vehicle computing device.

Optionally, the method 2000 may further comprise displaying the one or more predetermined destinations accessible from the predetermined zone on a graphical user interface of a client computing device 1500 associated with the user, and receiving an input via the graphical user interface selecting one of the one or more predetermined destinations as the end location. The predetermined destinations accessible from the zone may be provided in a list on the graphical user interface of the client computing device 1500. The user may select one of the predetermined destinations by tapping or clicking on the predetermined destination. The user may alternative give a voice instruction to the client computing device 1500 to select the predetermine destination. By listing the predetermined destinations, the graphical user interface restricts the possible destinations of the user to one of the predetermined destinations. Unlike other ride sharing platforms, the present transportation service platform improves the efficiency of the service by restricting the possible destinations that are accessible from a particular geographical zone. Users cannot use the transportation service platform to get rides to any destination whatsoever. Rides are restricted to a fixed set of predetermined destinations. The graphical user interface of the client computing device 1500 may be used to enforce this restriction.

Optionally, the method 2000 may further comprise receiving a request from the user for a further ride from a second start location to a second end location, wherein the second start location is the same as the end location, and wherein the second end location is another one of the one or more predetermined destinations, a location within the predetermined zone, or the start location. The user may require a further ride once the user has completed a task at the end location. For example, if the end location is a grocery store, the user may require a further ride once the user has completed the grocery shopping. The server 1200 may automatically schedule a further ride for the user based on a fixed amount of time to complete the task. Alternatively, the user may request a further ride once the task is complete. The user may enter the request via the client computing device 1500, which may send the request via the network 1300 to the server 1200, which may schedule the vehicle pickup. The user may request a ride to return to the initial start location. For example, after grocery shopping, the user may require a ride to return home. Alternatively, the user may wish to go to another predetermined destination. For example, once the user has completed grocery shopping, the user may wish to go to the pharmacy before returning home. As another alternative, the user may wish to go to another location in the predetermined zone that is different from the initial start location. For example, a user may wish to go grocery shopping on the way home from work. The user may take a ride from work to the grocery store. Once the grocery shopping is complete, the user may take another ride from the grocery store to home.

Optionally, the method 2000 may further comprise receiving a request from the user for a further ride from a second start location to a second end location, wherein the second start location is a predetermined location associated with a second predetermined zone, and wherein the second end location is within the second predetermined zone. In some embodiments, the second start location may be the same as the first end location. Some predetermined destinations may be accessible from more than one zone. The user may request a ride from the second start location to a second end location that is located in a second predetermined zone that is different from the first predetermined zone. The second end location may be in a zone from which the second start location is an accessible predetermined destination. For example, a user may wish to do grocery shopping on the way home from work. The user's work may not be in the same zone as the user's home. If the grocery store is a predetermined destination that is accessible from both the user's work zone and home zone, then the user may take the ride service from work to the grocery store and then from the grocery store to home. In another embodiment, the second start location may be different from the first end location. For example, the user may walk, drive, or take public transportation to go from the first end location to the second start location.

A skilled person will understand that a user may use the transportation service platform for multi-stop trips, and that there may be indefinitely many stops on the trip. Each subsequent end location may be accessible from each subsequent start location, such as for example if each subsequent end location is in the same zone as each subsequent start location.

Optionally, the method 2000 may further comprise determining the boundaries of the predetermined zones. The boundaries of the predetermined zones may be determined automatically by a computer, such as for example by the server 1200.

Optionally, the transportation service platform may charge a per use fee to the user for using the service to obtain a ride from the start location to the end location. The amount of the fee may depend on the distance and/or time it takes to arrive at the end location. Alternatively, the user may pay a monthly or annual fee to have access to the platform. The amount of the monthly or annual fee may depend on the frequency that the user uses the service, such as daily, weekly, or monthly. Optionally, a commercial destination, such as a store or shopping mall, may pay a fee to the transportation service platform in order to be listed as one of the predetermined destinations accessible from one or more zones. This fee may subsidize the transportation service, reducing or eliminating the fee for users of the service, thus making the service less expensive than alternatives, such as private vehicles, taxis, public transportation, or traditional ride sharing services.

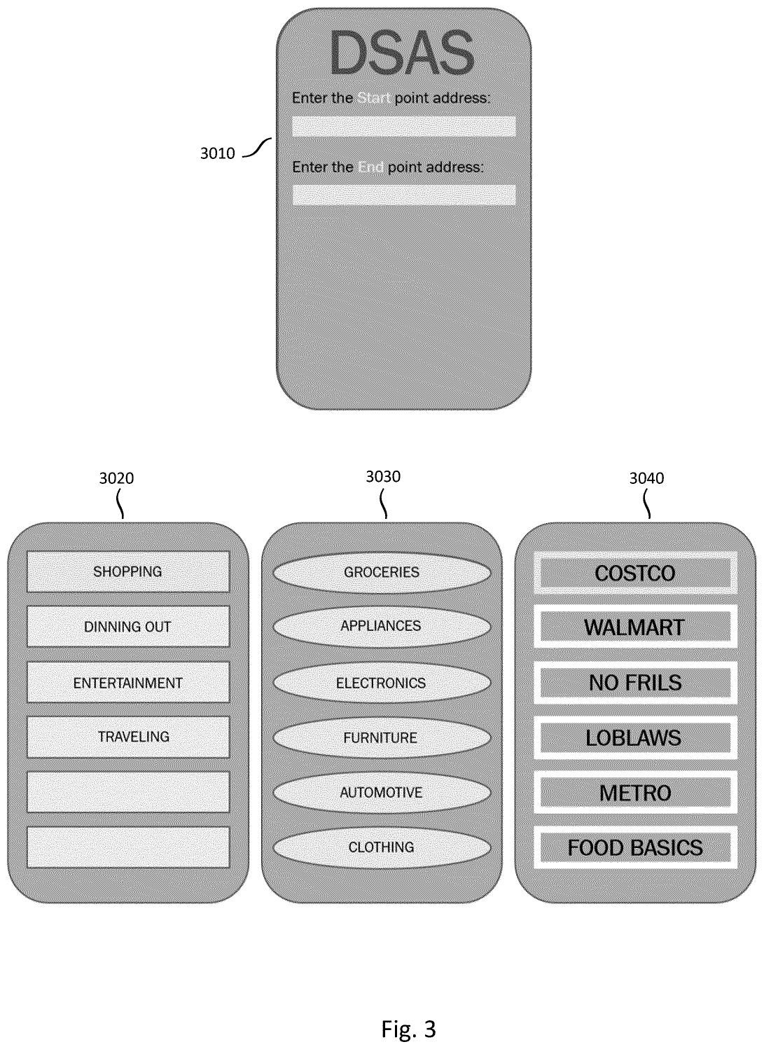

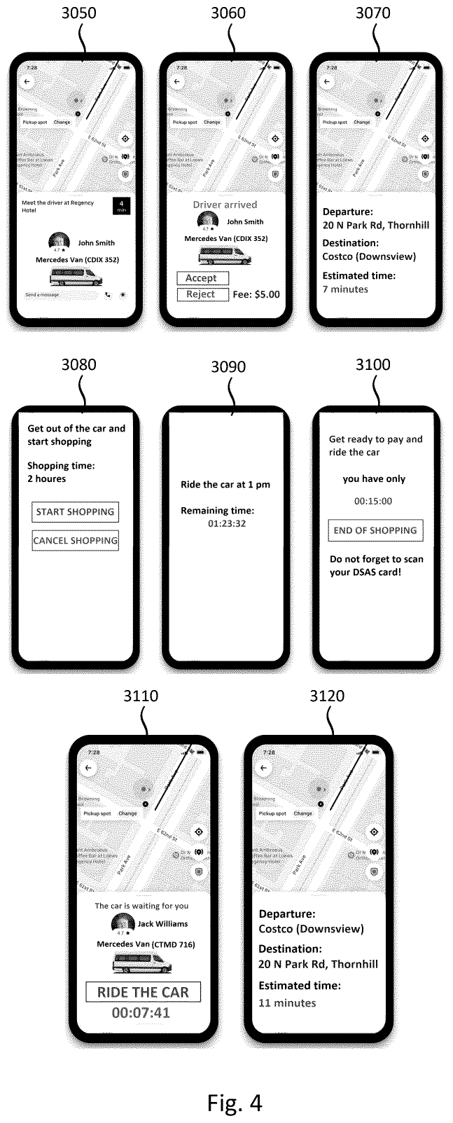

Reference is now made to FIG. 3 and FIG. 4, which show various graphical user interfaces (GUIs) of the client computing device 1500 for the transportation service platform. The GUI 3010 enables the user to request a ride from the transportation service platform by entering a start location address and an end location address. The user may select the end location from a fixed list or menu of predetermined destination options. The predetermined destinations may be arranged in a hierarchy of menus. GUI 3020 shows the first level in the hierarchy of menus, enabling the user to select the purpose of the trip. GUI 3030 shows the second level of the hierarchy of menus for the Shopping option in the first menu, which shows different types of shopping. GUI 3040 shows the third level in the hierarchy of menus for the Groceries option in the second menu. This menu lists the predetermined destinations (for example, grocery stores) that are accessible from the user's zone. GUI 3050 shows the location of the user and the vehicle on a map. GUI 3060 shows the vehicle and the cost of the ride and enables the user to accept or reject the ride. GUI 3070 shows the user interface while the user is in the vehicle. It shows the start location, the end location, and the estimated time of the ride. GUI 3080 shows the user interface once the user arrives at the end location. In this embodiment, the user may have a fixed amount of time to complete the shopping before the vehicle returns to pick the user up from the destination. GUIs 3090 and 3100 show the user interface while the user is shopping. They show the remaining time that the user has to shop until the vehicle returns. GUI 3110 shows the user and the vehicle on a map as the vehicle is returning to pick up the user at the end location. GUI 3120 shows the user interface while the user is returning home in the vehicle. It shows the start location, the end location, and the estimated time of the drive.

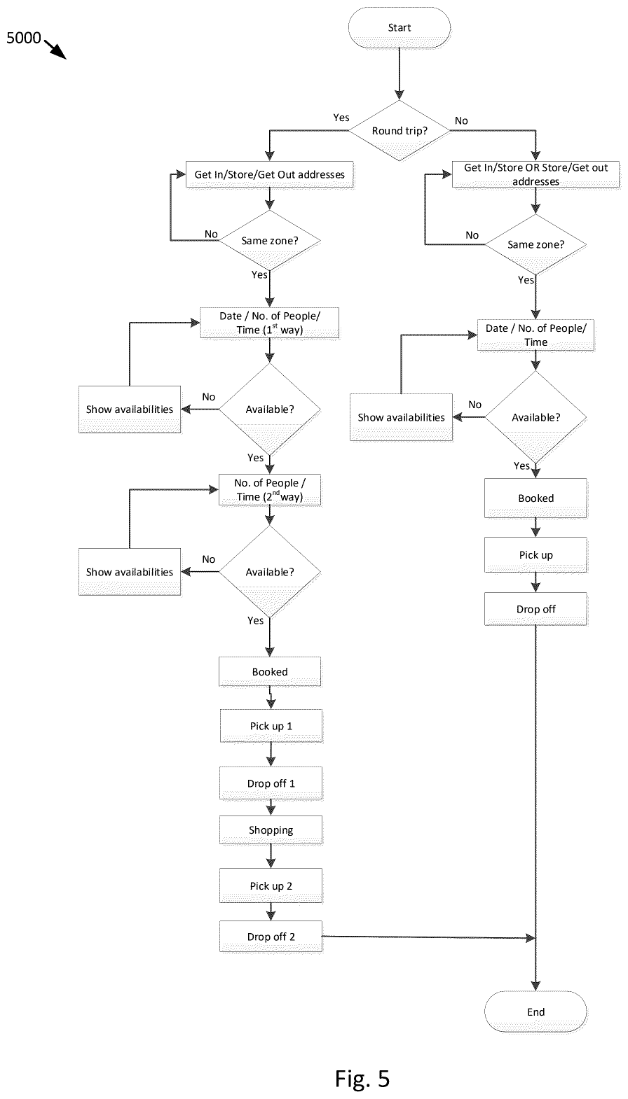

Reference is now made to FIG. 5, which shows a flow chart 5000 for the transportation service platform. There are two main options: either the user uses the transportation service for a round trip or the user uses the transportation service for a one-way trip. An example of a round trip may be if the user uses the transportation service to do grocery shopping and returns home after the shopping. An example of a one-way trip may be if the user uses the transportation service to go to the airport. In at least some embodiments, each one-way trip must be either to or from a predetermined destination. The various steps in the flow chart have been discussed above in connection with the other embodiments.

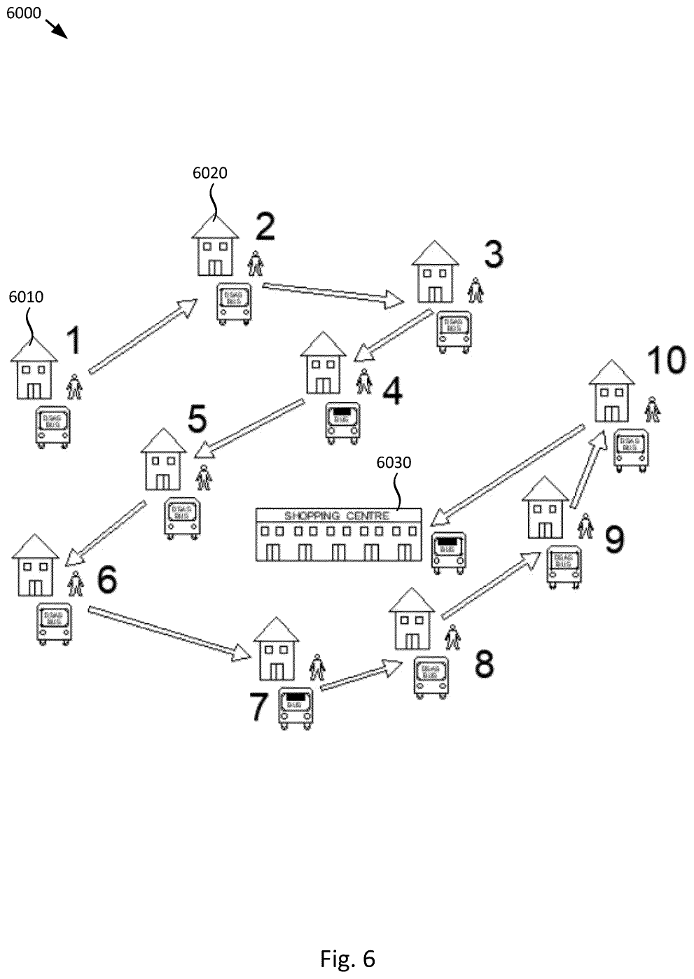

Reference is now made to FIG. 6, which shows an exemplary route 6000. The route 6000 may comprise a number of start locations of users, such as 6010 and 6020. Each of the start locations may be located in the same zone. The vehicle may pick up each of the users at each of the start locations 6010, 6020 along the route. The last stop on the route may be the end location 6030. In this example, each of the users at the start locations 6010, 6020 may be going to the same end location 6030, such as a shopping mall.

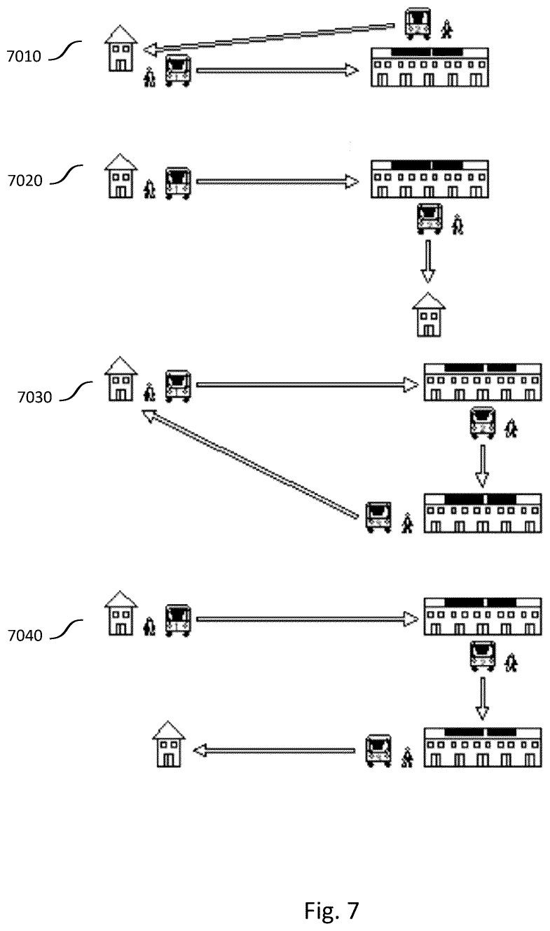

Reference is now made to FIG. 7, which shows different possible routes for the users of the transportation service platform. In the first option 7010, the user may use the transportation service to get a ride from a start location to a predetermined destination and then return to the same start location. For example, the user may take a ride from their home to the grocery store and then return home. In this option, the transportation service may be used to provide a round trip. In the second option 7020, the user may use the transportation service to get a ride from a start location to a predetermined destination and then a second ride to another location different from the original start location. For example, the user may use the transportation service to go grocery shopping on the way home from work. The user takes a first ride from work to the grocery store, and a second ride from the grocery store to home. In the third option 7030, the user may use the transportation service to go to more than one predetermined destination before returning to the same initial start location. For example, the user may take a ride from their home to the grocery store, from the grocery store to the pharmacy, and from the pharmacy back to their home. In a fourth option 7040, the user may use the transportation service to take a ride from a start location to a first predetermined destination, from the first predetermined destination to a second predetermined destination, and from the second predetermined destination to a final location that is different from the start location. For example, the user may wish to do grocery and pharmacy shopping on the way home from work. The user may take a ride from work to the grocery store, from the grocery store to the pharmacy, and from the pharmacy home.

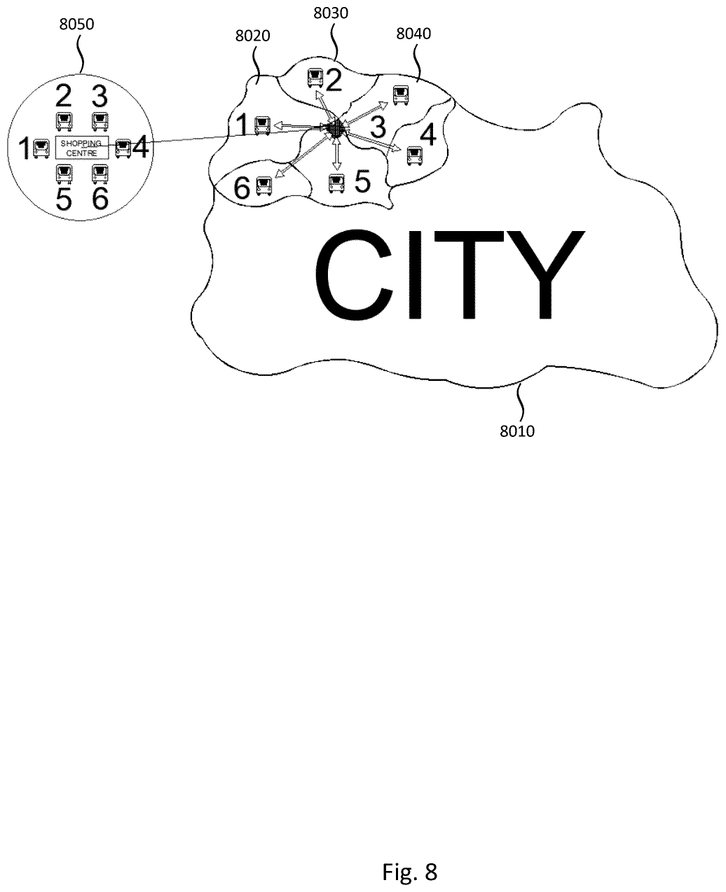

Reference is now made to FIG. 8, which shows a city 8010 divided up into a plurality of zones 8020, 8030, and 8040. In this example, the zones do not exhaust the city 8010. There are parts of the city 8010 that are not covered by any zone. The transportation service may not be available to users located in these gaps. In this example, the zones 8020, 8030, and 8040 are mutually exclusive; the zones do not overlap. The predetermined destination 8050 is accessible from all the zones 8020, 8030, 8040. Users from any of the zones may access the predetermined destination 8050. Once users arrive at the predetermined destination 8050, they may use the transportation service to take a ride to any location of any of the zones 8020, 8030, or 8040. They do not need to return to the same zone they came from.

It will be understood that corresponding system embodiments are disclosed for each of the method embodiments disclosed herein, for example where the system comprises respective components having computation circuitry configured to perform the operations of the computer implemented method embodiments.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored therein.

While the computing devices are described with reference to processors and instructions that, when executed, cause the computing devices to perform operations, it is understood that other types of circuitry than programmable processors can be configured. Hardware components comprising specifically designed circuits can be employed such as but not limited to an application specific integrated circuit (ASIC) or other hardware designed to perform specific functions, which may be more efficient in comparison to a general purpose central processing unit (CPU) programmed using software. Thus, broadly herein an apparatus aspect relates to a system or device having circuitry (sometimes referenced as computational circuitry) that is configured to perform certain operations described herein, such as, but not limited, to those of a method aspect herein, whether the circuitry is configured via programming or via its hardware design.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

The processor module 1230 may represent a single processor with one or more processor cores or an array of processors, each comprising one or more processor cores. The memory module 1220 may comprise various types of memory (different standardized or kinds of Random Access Memory (RAM) modules, memory cards, Read-Only Memory (ROM) modules, programmable ROM, etc.). The storage module 1400 may represent one or more logical or physical as well as local or remote hard disk drive (HDD) (or an array thereof). The storage module 1400 may further represent a local or remote database made accessible to the network node 1200 by a standardized or proprietary interface. The network interface module 1210 represents at least one physical interface that can be used to communicate with other network nodes. The network interface module 1210 may be made visible to the other modules of the network node 1200 through one or more logical interfaces. The actual stacks of protocols used by the physical network interface(s) and/or logical network interface(s) of the network interface module 1400 do not affect the teachings herein. The variants of processor module 1230, memory module 1220, network interface module 1210 and storage module 1400 usable in the context will be readily apparent to persons skilled in the art. Likewise, even though explicit mentions of the memory module 1220 and/or the processor module 1230 are not made throughout the description of the present examples, persons skilled in the art will readily recognize that such modules are used in conjunction with other modules of the network node 1200 to perform routine as well as innovative steps related to the present disclosure.

It is understood that client computing device 1500 comprises similar components to server 1200 that is typically configured appropriately for a client and as a user device.

Various network links may be implicitly or explicitly used in the context shown and described herein. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The teachings herein are not affected by the way the different modules exchange information between them. For instance, the memory module and the processor module could be connected by a parallel bus, but could also be connected by a serial connection or involve an intermediate module (not shown) without affecting the teachings herein.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description has been presented for purposes of illustration but is not intended to be exhaustive or limited to the disclosed embodiments. Many modifications and variations will be apparent to those of ordinary skill in the art. The embodiments were chosen to explain the principles of the teachings herein and their practical applications and to enable others of ordinary skill in the art to understand the teachings in order to implement various embodiments with various modifications as might be suited to other contemplated uses.

What is claimed is:

1. A computer-implemented method, the method comprising:
receiving a request from a user for a ride from a start location to an end location, the start location being located within a predetermined zone associated with one or more predetermined destinations accessible from the predetermined zone, the end location being restricted to one of the predetermined destinations, the predetermined zone comprising at least one other user having requested a ride to at least one other end location from at least one other start location within the predetermined zone;
calculating a route from a location of a vehicle to the end location, the route comprising the start location and the at least one other start location; and
dispatching, via a vehicle computing device associated with the vehicle, the vehicle to follow the route.

2. The method of claim 1, wherein the one or more predetermined destinations are located in proximity to one another.

3. The method of claim 1, wherein the one or more predetermined destinations are located within the predetermined zone.

4. The method of claim 1, wherein the one or more predetermined destinations are located in proximity to the predetermined zone.

5. The method of claim 1, wherein the predetermined zone is associated with only one predetermined destination.

6. The method of claim 1, wherein the end location is the same as the at least one other end location.

7. The method of claim 1, wherein the predetermined zone is one of a plurality of predetermined zones in a city.

8. The method of claim 7, wherein locations and areas of the plurality of predetermined zones are determined based on locations of commercial destinations, population distribution and size, shopping patterns, or traffic patterns.

9. The method of claim 7, wherein two or more of the plurality of predetermined zones overlap.

10. The method of claim 1, further comprising calculating a pickup time for the user based on traffic patterns, availability of the vehicle, availability of the at least one other user, or a level of busyness at the end location.

11. The method of claim 1, wherein at least one of the predetermined destinations is a commercial destination or a transportation hub.

12. The method of claim 1, wherein at least one of the predetermined destinations is a mall, a shopping centre, a pharmacy, a grocery store, a big box store, a department store, a restaurant, a bar, a cinema, a university, a school, an event, a festival, a main street, or a downtown shopping district.

13. The method of claim 1, wherein the vehicle is restricted to providing rides to users located within the predetermined zone.

14. The method of claim 1, further comprising sending the route to the vehicle computing device for display on a graphical user interface thereof.

15. The method of claim 1, further comprising:
displaying the one or more predetermined destinations accessible from the predetermined zone on a graphical user interface of a user computing device associated with the user; and
receiving an input via the graphical user interface selecting one of the one or more predetermined destinations as the end location.

16. The method of claim 1, further comprising receiving a further request from the user for a further ride from a second start location to a second end location, wherein the second start location is the same as the end location, and wherein the second end location is another one of the one or more predetermined destinations, a location within the predetermined zone, or the start location.

17. The method of claim 1, further comprising receiving a further request from the user for a further ride from a second start location to a second end location, wherein the second start location is a predetermined location associated with a second predetermined zone, and wherein the second end location is within the second predetermined zone.

18. The method of claim 1, further comprising determining the boundaries of the predetermined zones.

19. A non-transitory computer-readable medium comprising computer instructions stored thereon, wherein the computer instructions, when executed by one or more processors, causes the one or more processors to perform the method of any one of claims 1-18.

20. A computing device comprising one or more processors operable to perform the method of any one of claims 1-18.
